(19) United States
(12) Patent Application Publication
(10) Pub. No.: US 2006/0057362 A1
(43) Pub. Date: Mar. 16, 2006

(54) Coatings containing nanotubes, methods of applying the same and transparencies incorporating the same

(76) Inventors: Renhe Lin, Valencia, CA (US); Liming Dai, Hudson, OH (US); Wei Chen, Kettering, OH (US)

Correspondence Address: CHRISTIE, PARKER & HALE, LLP, PO BOX 7068, PASADENA, CA, 91109-7068, US

(21) Appl. No.: 11/087,525

(22) Filed: Mar. 23, 2005

Related U.S. Application Data
(60) Provisional application No. 60/555,658, filed on Mar. 23, 2004.

(51) Int. Cl. B32B 5/16; B32B 27/40; B32B 27/30

(52) U.S. Cl. 428/323; 428/423.1; 428/522; 428/447; 427/162; 427/180

(57) ABSTRACT

A coating on a transparency is provided. In an exemplary embodiment the coating is conductive and transparent. Furthermore, a method for forming a transparency with such a coating is provided.

### CROSS REFERENCE TO RELATED APPLICATION

This application claims the benefit of U.S. Provisional Application No. 60/555,658 filed on Mar. 23, 2004, the contents of which are fully incorporated herein by reference.

### BACKGROUND OF THE INVENTION

This invention relates to transparent coatings and to transparent conductive containing nanotubes and to transparencies, as for example aircraft transparencies, coated with the same as well as to methods of applying such coatings. Such coatings can be used for anti-static or static dissipative applications, including on aircraft transparencies such as canopies.

Most transparent coatings used to coat transparencies, such as aircraft canopies, contain organic polymers which generally are poor conductors of electricity. Consequently, these polymers cannot be used satisfactorily in applications where static dissipative properties are required, as for example in aircraft canopies. To achieve static dissipation, various approaches have been proposed. These approaches include adding anti-static agents to the coating formulations, adding metal oxide fillers, such as indium tin oxide particles or antimony tin oxide particles to the coating formulations, and adding conductive polymers to the coating formulations.

Each of these approaches has disadvantages. Anti-static agents' performance decreases dramatically at low humidity and/or low temperature. Metal oxide fillers, such as indium tin oxide particles or antimony tin oxide particles can provide high surface conductivity. However, a large amount of metal oxide filler is required to achieve surface conductivity. Moreover, the conductive fillers reduce the coating's light transmission abilities. Conductive polymers have poor weatherability, thus their performance deteriorates dramatically when exposed to ultra violet rays. In addition, conductive polymers reduce the coating's light transmission abilities.

Consequently, there is a need to enhance the electrical conductivity of transparent coatings without adversely affecting the coating's transparency. The present invention fulfills this need and provides further related advantages.

### SUMMARY OF THE INVENTION

The present invention relates to transparent conductive coating compositions incorporating nanotubes such as carbon nanotubes, and to transparencies such as aircraft transparencies incorporating the same. The nanotubes in the coatings enhance electrical conductivity without adversely affecting the composition's light transparency. Exemplary coating compositions are formed by mixing resins, such as transparent resins, with nanotubes, such as carbon nanotubes. Exemplary coating resins include polyurethane, polysiloxane, acrylate, and phenolic resins. Exemplary embodiment coating compositions contain nanotubes in an amount 0.01 to 30.0 weight percent of the total amount of coating resin in the composition.

In one exemplary embodiment, a conductive coating is formed by mixing about 100 parts by weight of a transparent polyurethane coating, such as Sierracin Corporation's (“Sierracin's”) FX-318 resin, with about 5 parts by weight carbon nanotubes. In another exemplary embodiment, a conductive coating is formed by mixing about 100 parts by weight of a transparent polysiloxane resin, such as Sierracin's FX-307 resin, with about 3 parts by weight carbon nanotubes. In yet another exemplary embodiment, a conductive coating is formed by mixing about 100 parts by weight of a transparent acrylate resin, such as Sierracin's FX-325 resin with about 3 parts by weight carbon nanotubes.

In a further exemplary embodiment a transparent coating is provided incorporating nanotubes and having a surface sheet resistance of about 10¹⁰ ohms/square at ambient conditions. In another exemplary embodiment a transparent coating is provided having a surface sheet resistance of about 10¹⁰ ohms/square at −40° F. In a further exemplary embodiment a conductive transparent coating is provided whose sheet resistance does not deteriorate when operating in low humidity and/or low temperature, as for example when operating at −40° F., in comparison to the coating's sheet resistance at ambient conditions. In another exemplary embodiment a transparent coating is provided having nanotubes and having static dissipative properties. In a further exemplary embodiment, a transparent coating is provided formed by mixing a transparent resin with nanotubes where the nanotubes make up from about 0.1% to about 30% of the resin-nanotube composition by weight. In yet another exemplary embodiment, an aircraft transparency such as an aircraft canopy is provided coated with any of the aforementioned exemplary embodiment coatings.

In another exemplary embodiment a coated transparency is provided. The coated transparency includes a transparency and a coating on the transparency having nanotubes. The coating may be transparent and/or conductive. In an exemplary embodiment, the coating includes a resin selected from the group of resins consisting of polysiloxane, polyurethane and acrylate. In another exemplary embodiment the nanotubes are pre-mixed or coated with polyaniline. In yet a further exemplary embodiment, the coated transparency has a light transmission of at least about 70%.

In another exemplary embodiment a method is provided for forming a coated transparency. The method includes providing a transparency, applying a resin to the transparency, and spraying nanotubes onto the resin. In a further exemplary embodiment prior to spraying, the nanotubes are dispersed in a solvent. In an exemplary embodiment, the solvent may be selected from the group of solvents consisting of water, ethanol and dimethyl formamide (DMF). Furthermore, the nanotubes may be pre-mixed or coated with polyaniline. In an exemplary embodiment, the resin is selected from the group of resins consisting of polysiloxanes, polyurethanes and acrylates.

In yet a further exemplary embodiment, a method for forming a coated transparency is provided. The method includes providing a transparency, mixing nanotubes with a resin, and applying the resin to the transparency. In an exemplary embodiment, the resin is selected from the group of resins consisting of polysiloxanes, polyurethanes and acrylates. In another exemplary embodiment, the method includes coating the nanotubes with polyaniline. This may be accomplished by mixing the nanotubes in a polyaniline solution. In yet a further exemplary embodiment, prior to coating the nanotubes with polyaniline, the nanotubes are dispersed in an aqueous solution of sodium dodecylsulfate. In another exemplary embodiment, the polyaniline may be doped with dodecyl benzenesulfonic acid. In a further exemplary embodiment, the polyaniline may be mixed with a solvent selected from the group of solvents consisting of CHCl₃, tetrahydrofuran, ethanol, isopropanol and acetone. In another exemplary embodiment, the nanotubes may be dispersed in a solvent selected from the group of solvents consisting of water, ethanol, CHCl₃, tetrahydrofuran and dimethyl formamide.

In a further exemplary embodiment, the nanotubes or a nanotube solution as described above is spread over a layer of resin which is applied over a transparency.

### BRIEF DESCRIPTION OF THE DRAWINGS

FIG. 1 is a graph of the light transmittance of films obtained by spraying single wall nanotubes onto FX-307 resin film.

FIG. 2 is a graph of the light transmittance of films obtained by spraying single wall nanotubes onto FX-407 film.

FIG. 3 is a schematic of a slider applying a coating of the present invention onto a transparency.

FIG. 4 is a graph of the light transmittance of films obtained from polyaniline/single wall nanotubes mixture with an FX-406 coating.

### DESCRIPTION OF EXEMPLARY EMBODIMENTS

In an exemplary embodiment, the present invention provides for transparent coating compositions that incorporate carbon nanotubes to increase the coating's electrical conductivity without adversely affecting the coating's transparency. In exemplary embodiments, the carbon nanotubes have a length to diameter ratio in the range of 10:1 to 10000:1. Exemplary coating compositions are formed by mixing resin solutions, i.e., solutions comprising a resin and solvent, with nanotubes, such as carbon nanotubes. The inventive coating compositions are ideal for use in coating aircraft transparencies such as aircraft canopies. The inventive coating's enhanced conductivity minimizes the possibility of static charge buildup to the point where a shock hazard is created or damage to the transparency occurs.

The coating compositions of this invention can best be understood by reference to the following examples. In each of the following examples, the carbon nanotube surfaces may have to be chemically modified introducing various chemical groups to such surfaces so as to promote the uniform dispersion of the carbon nanotubes within the resin solution. Moreover, methods of uniform dispersion of the nanotubes in the resin solution may also have to be devised. Both carbon nanotube surface chemical modification and the method of dispersion can be ascertained by experimentation. Various surface modification methods have been proposed in the literature for the introduction of various chemical groups to the nanotube surfaces. For example, the surface chemical modification can be achieved using methods such as chemical grafting, non-depositing plasma treatment, plasma polymerization, radio-frequency glow discharge, and/or acid treatment. Many institutions, such as the University of Dayton, Rice University, University of Kentucky, Michigan State University, University of Texas, University of Pennsylvania, University of California at Berkeley and Clemson University (collectively “institutions”) all have the equipment necessary for ascertaining the surface treatment of the nanotubes and for ascertaining a method for uniformly dispersing the nanotubes into the resin solution. The carbon nanotubes needed for the inventive coatings may be obtained from such institutions. More information relating to the acquisition and treatment of nanotubes can be found at the web site http://www.pa.msu.edu/cmp/csc/NTSite/nanopage.html#addresses.

The effectiveness of the carbon nanotube surface treatment can be verified using various well-known methods, as for example, X-Ray Photoelectron Spectroscopy (XPS), Scanning Electron Microscopy (SEM), Attenuated Total Reflectance Fourier Transform Infrared Spectroscopy (ATR-FTIR), Atomic Force Microscopy (AFM), and Nuclear Magnetic Resonance (NMR).

### EXAMPLE 1

In this example a transparent polyurethane coating incorporating nanotubes is provided. The coating is formed by mixing a transparent aliphatic polyurethane resin solution (i.e., a solution of transparent aliphatic polyurethane resin and solvent), as for example Sierracin's FX-318 resin obtained from Sierracin, the assignee of this application, with carbon nanotubes. An exemplary conductive transparent polyurethane coating formulation is shown in Table 1.

TABLE 1
Conductive Polyurethane Coating Formulation

| Compositions | Parts by Weight |
|---|---|
| FX-318 | 100 |
| Carbon Nanotubes | 5 |

To achieve a stable mixture of nanotubes in FX-318, the nanotube surfaces need to be chemically modified to introduce hydroxyl groups to the nanotube surfaces. When such treated nanotubes are mixed with the polyurethane resin, the hydroxyl groups on the nanotube surfaces react with the polyurethane resin, resulting in a stable and uniform dispersion of the nanotubes in the polyurethane resin solution.

### EXAMPLE 2

In this example, a transparent polysiloxane coating incorporating nanotubes is provided. A transparent polysiloxane resin solution (i.e., a solution of transparent polysiloxane resin and solvent), as for example Sierracin's FX-307 resin obtained from Sierracin, is mixed with nanotubes in accordance with the formulation shown in Table 2.

TABLE 2
Conductive Polysiloxane Coating Formulation

| Compositions | Parts by Weight |
|---|---|
| FX-307 | 100 |
| Carbon Nanotubes | 3 |

In Example 2, the nanotube surfaces also need to be chemically modified to introduce silanol groups to the surfaces. When such treated carbon nanotubes are mixed with polysiloxane resin, the silanol groups on the nanotube surfaces react with polysiloxane resin, resulting in a stable and uniform dispersion of nanotubes in the polysiloxane resin solution.

### EXAMPLE 3

In this example, a conductive transparent acrylate coating incorporating nanotubes is provided. A transparent acrylate resin solution (i.e., a solution of acrylate resin and solvent), as for example Sierracin's FX-325 resin obtained from Sierracin, is mixed with carbon nanotubes in accordance with the formulation shown in Table 3.

TABLE 3
Conductive Acrylate Coating Formulation

| Compositions | Parts by Weight |
|---|---|
| FX-325 | 100 |
| Carbon Nanotubes | 3 |

In Example 3, the nanotube surfaces also need to be chemically modified to introduce vinyl groups to the surfaces. When such treated carbon nanotubes are mixed with acrylate resin, the vinyl groups on the nanotube surfaces copolymerize with the acrylate resin, resulting in a stable and uniform dispersion of nanotubes in the acrylate resin solution.

All three exemplary coatings described herein are expected to have a surface sheet resistance of about 10¹⁰ ohms/square at ambient conditions and at −40° F. In other words, the coatings' surface sheet resistance will not be effected by a decrease in temperature. The same coatings, i.e., resins without the carbon nanotubes have no conductivity at ambient conditions nor at −40° F. Moreover, the exemplary coatings described herein are expected to have 80% and even 90% light transmission or better at a wavelength of about 400 nm to about 1100 nm at ambient conditions as measured using a UV-Vis spectrometer. Transparancies coated with such coatings are expected to have a light transmission of at least 70% at a wavelength of about 400 nm to about 1100 nm. Consequently, the performance of the inventive coatings does not deteriorate at low humidity and/or temperature. Moreover, the inventive coatings ability to transmit light is not compromised in comparison with conventional transparent coatings or in comparison with coatings not incorporating nanotubes.

In either of the aforementioned examples, the nanotubes may be pre-mixed or coated with a conductive polymer such as polyaniline. This may be accomplished by blending the nanotubes with the conductive polymer prior to mixing with the resin. It should be noted that some polymers other than polyaniline may be conductive but may become an insulator when they are attached to the nanotubes. Consequently, such other polymers may not be suitable for use in forming the coatings of the present invention.

The nanotubes treated with the polyaniline are mixed with the coating solution, i.e. resin, which may in an exemplary embodiment be a polysiloxane, polyurethane or acrylate. When mixed with acrylate resin to form the coating, the coating may require to be UV cured after it is applied to a transparency. The other coatings may be cured by heat, as for example by heating the coating in an oven.

Examples 4 to 6 following provide descriptions and measured data for exemplary embodiment coatings on transparencies. The nanotubes used in these examples are carbon nanotubes obtained from Carbon Nanotechnologies Incorporated at Rice University, Houston, Tex.

### EXAMPLE 4

A solution of FX-307 or Sierracin's FX-406 A and B resin having a 1:1 by weight FX-406A and FX-406B resin, was coated on poly(ethylene terephthalate) (PET) transparent films (i.e., transparencies) to obtain about 100 μm resin coating films after drying at room temperature. Then the dispersion of single-wall nanotubes (SWNTs) in different solvents (e.g. water, ethanol, and DMF) was sprayed onto the resin coating films for several times. The films were allowed to dry after each time of spraying. In one exemplary embodiment, prior to dispersing in the solvent, 4 grams of SWNTs were dispersed in a water solution containing sodium dodecylsulfate forming a nanotube solution. One ml of nanotube solution is dispersed in 25 ml of solvent such as water, ethanol or DMF, forming a nanotube solution to be applied to the resin film.

Table 4 summaries the surface resistance of coatings obtained by spraying SWNTs onto the FX-307 resin coating film. These measurements were made after the coatings were cured. In the case of spraying SWNTs mixed in water or ethanol, the surface resistance decreased from 10¹² Ω/square to 10¹¹ Ω/square. Surface resistivity was measured using a PSI-870 Surface and Resistance and Resistivity Indicator, made by ProStat Corporation, Bensenville, Ill. 60106. A decrease in surface resistivity causes an increase in surface conductivity which in turn causes an increase in the coatings anti-static performance. The increase of surface conductivity is caused by formation of SWNTs network on the surface of FX-307 resin film. However, the FX-307 film could be partially destroyed by ethanol after 50 times of spraying. By using DMF as the solvent, the FX-307 resin film was totally destroyed and no surface resistance reading could be made.

TABLE 4
Surface Resistance of films obtained by spraying SWNTs
onto the FX-307 coating film.

| | | Surface Resistance |
|---|---|---|
| Code | Composition | (Ω/square) |
| FX307 | Pure FX-307 film | ≧10¹² |
| SPW30 | Spraying SWNTs in water for 30 | 10¹¹ |
| | times | |
| SPE30 | Spraying SWNTs in ethanol for | 10¹¹ |
| | 30 times | |
| SPE50 | Spraying SWNTs in ethanol for | 10¹¹ |
| | 50 times | |
| SPD | Spraying SWNTs in DMF | FX307 film destroyed |

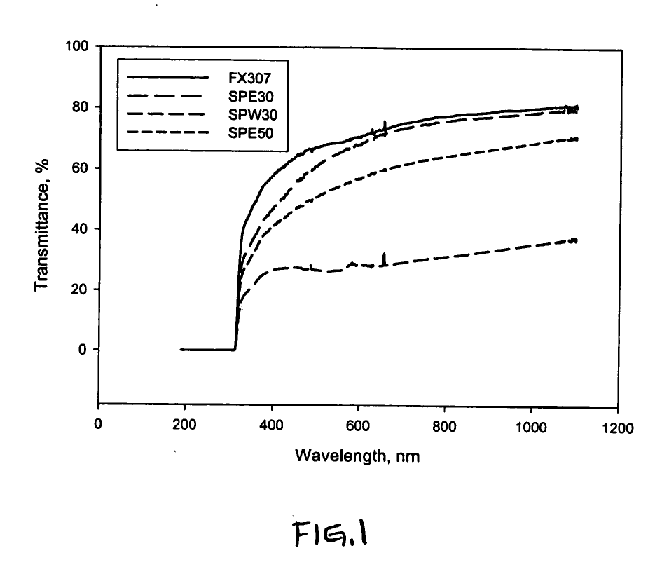

FIG. 1 shows the light transmittance of films obtained by spraying SWNTs onto FX-307 resin film. When the spraying was limited to 30 times, the light transmittance of film was almost the same by using ethanol as solvent, because ethanol could form a thin liquid film on the surface of FX-307 film. It should be noted that each spraying “time” is a spraying of a layer of nanotubes over the resin. The thin liquid film of ethanol helped the dispersion of SWNTs on the surface of FX-307 film. When the spraying times reached 50 times, the FX-307 film was partially destroyed by ethanol and the transmittance also decreased sharply.

### EXAMPLE 5

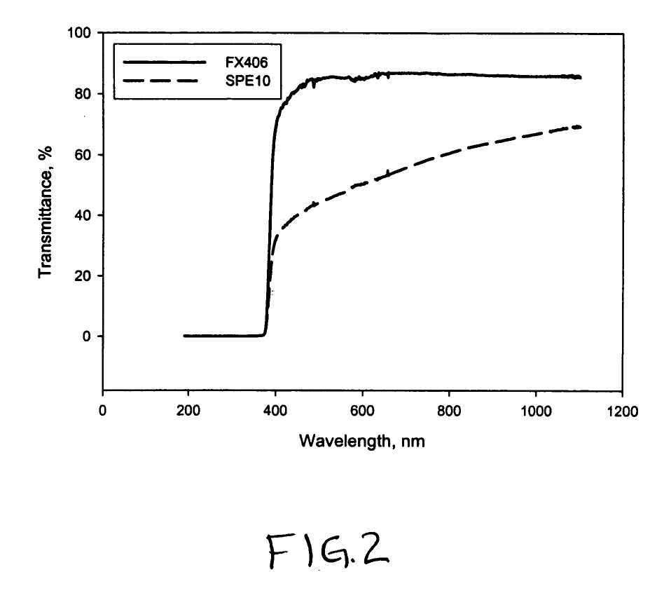

Table 5 summarizes the surface resistance of films obtained by spraying SWNTs onto the FX-406 coating film. The nanotube solution applied to the FX-406 resin film was prepared as described in Example 4. After 10 times of spraying SWNTs in ethanol, the surface resistance of the resulting coating decreased from 10¹² Ω/square to 10¹¹ Ω/square. Because of the high light transmittance of FX-406 resin film, the SWNTs network covered film also showed a high light transmittance as shown in FIG. 2.

TABLE 5
Surface Resistance of films obtained by spraying SWNTs
onto the FX-406 coating film.

| | | Surface Resistance |
|---|---|---|
| Code | Composition | (Ω/square) |
| FX406 | Pure FX-406 film | ≧10¹² |
| SPE10 | Spraying SWNTs in ethanol for | 10¹¹ |
| | 10 times | |

### EXAMPLE 6

Coatings may be formed with both multi-wall carbon nanotubes (MWNTs) and single-wall carbon nanotubes (SWNTs). In a typical experiment, a desired amount of multi-wall carbon nanotubes (MWNTs) were added to 10 ml coating solution of FX-307 resin, followed by sonication for 5 minutes. Sonication was accomplished in a Branson 2510R sonicator. The mixtures were then coated on PET transparent films. Single wall carbon nanotubes (SWNTs) were firstly dispersed with a concentration of 4 g/L in the aqueous solution of sodium dodecylsulfate (SDS). The SWNTs dispersion was then added to 5 ml coating solution of FX-307 resin, followed by sonication for 5 minutes. The mixtures were finally coated on PET transparent films. All the resulting coating films were about 100 μm in thickness.

A conductive polymer, polyaniline, was used to increase the conductivity. The polyaniline was firstly doped with dodecyl benzenesulfonic acid. In an exemplary embodiments, the nanotubes were mixed with the polyaniline prior to mixing with the resin. In an alternate exemplary embodiment, the nanotubes, polyaniline and resin where mixed together. It is believed that the polyaniline adheres to the outer surfaces of the nanotubes.

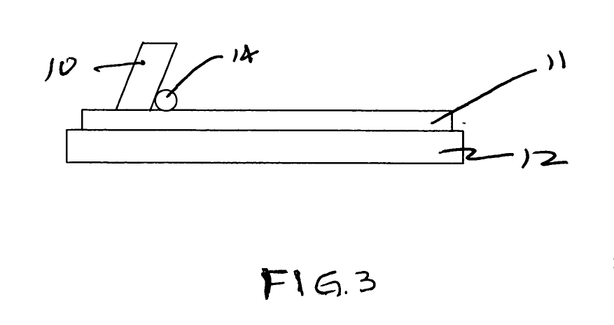

Three methods (i.e. scratching, spraying, and mixing) of incorporating nanotubes into coatings applied on a transparency were explored based on the FX-406 resin by Sierracin. In the scratching method, a small amount of nanotube solution 14 is applied on a resin layer 11 applied on a transparency 12. A slider 10 is slid over the resin layer 11, as for example shown in FIG. 3. The slider in essence spreads in the resin layer formed over the transparency.

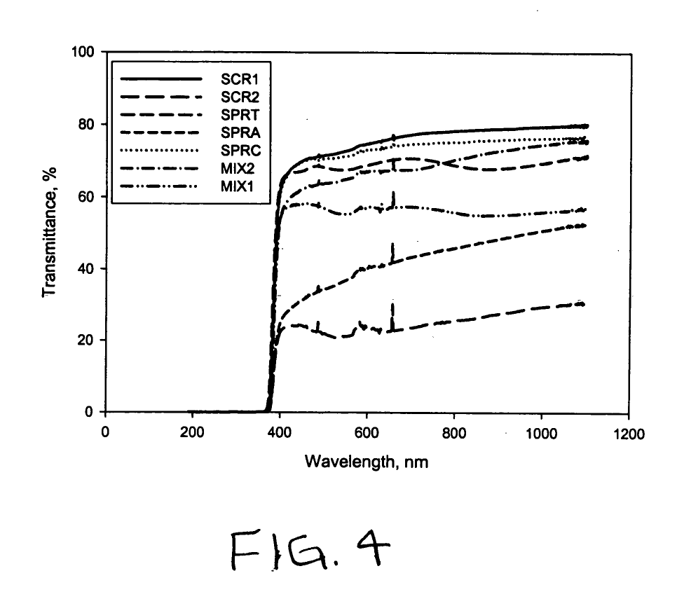

The resulting surface resistances of all the samples are summarized in Table 6. The concentration of the SWNT dispersion for scratching was 0.1 mg SWNTs in 50 ml of polyaniline solution in CHCl₃ at a concentration of 80 mg polyaniline per liter of CHCl₃. The SWNT coating thickness depends on the scratching pressure. The thin layer of polyaniline/SWNT on the FX-406 resin film decreased the surface resistance dramatically from 10¹² to 10⁸ Ω/square for SCR1 sample. An increase in the thickness of polyaniline/SWNT layer further decreased the surface resistance. However, the thick polyaniline/SWNT layer would hinder the transmittance of lights, as shown in FIG. 4.

TABLE 6
Surface resistanceof FX-406 coating/polyaniline/SWNT system.

| | | |
|---|---|---|
| | | Surface |
| | | Resistance |
| Code | Composition | (Ω/square) |

| | | |
|---|---|---|
| FX406 | Pure FX-406 film | ≧10¹² |
| SCR1 | Scratching POLYANILINE/SWNTs in | 10⁸ |
| | CHCl₃ | |
| SCR2 | Scratching POLYANILINE/SWNTs in | 10⁷ |
| | CHCl₃ | |
| SPRA | Spraying POLYANILINE/SWNTs in | 10¹⁰ |
| | ethanol for 10 times | |
| SPRT | Spraying POLYANILINE/SWNTs in THF | 10⁹ |
| | for 10 times | |
| SPRC | Spraying POLYANILINE/SWNTs in CHCl₃ | 10⁹ |
| | for 10 times | |
| MIX1 | Solution mixing POLYANILINE with | 10¹¹ |
| | FX-406 A/B | |
| MIX2 | Solution mixing POLYANILINE/SWNTs | 10¹¹ |
| | with FX-406 A/B | |

The spraying method was also employed to form thin layers on the FX-406 resin films. The concentration of solution used in this method was 0.1 mg SWNTs dispersed in 50 ml polyaniline solution. The polyaniline solution was composed of 6 mg polyaniline per liter of solvent. The solvent was ethanol, CHCl₃ or tetrahydrofuran (THF). When using ethanol as a solvent, the surface resistance decreased to 10¹⁰ Ω/square. Because the polyaniline was not dissolved well in ethanol, aggregates formed on the film surface. Therefore, the transmittance of light became very low (FIG. 4). To increase the solubility of polyaniline, CHCl₃ and THF were used as the solvents. In these two cases, the surface resistance both decreased to the range of 10⁹ Ω/square. However, the film obtained from chloroform had higher transmittance than that from THF as shown in FIG. 4 because CHCl₃ was a better solvent for the polyaniline. Isopropanol and acetone may also be used as solvents.

The films obtained from solution mixing of polyaniline with SWNTs in CHCl₃ with FX-406 A/B resin film showed a decreased surface resistance when compared with pure FX-406 resin films. The polyaniline/SWNT solution was made by adding 0.1 mg SWNTs into 50 ml polyaniline solution in CHCl₃ at a concentration of 80 mg polyaniline per liter of CHCl₃. The polyaniline/SWNTs solution, FX-406 A, and FX-406 B were then mixed at a ratio of 2:4:4 by volume. Then the mixture was used to cast a film at room temperature. Surprisingly, the film with SWNTs had a higher transmittance of light than a film coated with resin mixed with polyaniline only. This phenomenon suggests the existence of polyaniline could help the dispersion of SWNTs in FX-406 resin film.

Applicant believes that embodiments of the inventive transparent coatings may also be formed comprising a transparent resin and nanotubes where the nanotubes by weight make up from about 0.1% to about 30% of the resin-nanotube composition. Moreover, the inventive coatings may be applied to transparencies such as aircraft transparencies using well-known methods, as for example flow coat methods.

The preceding merely illustrates the principles of the invention. It will thus be appreciated that those skilled in the art will be able to devise various arrangements which, although not explicitly described or shown herein, embody the principles of the invention and are included within the scope and spirit. Furthermore, all examples and conditional language recited herein are principally intended expressly to be only for pedagogical purposes and to aid in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and the functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of the present invention is embodied by the appended claims.

1. A coated transparency comprising:
a transparency; and
a coating on the transparency comprising nanotubes.

2. The coated transparency as recited in claim 1 wherein the coating is transparent.

3. The coated transparency as recited in claim 1 wherein the coating is conductive.

4. The coated transparency as recited in claim 3 wherein the coating is transparent.

5. The coated transparency as recited in claim 1 wherein the coating comprises a resin selected from the group of resins consisting of polysiloxane, polyurethane and acrylate.

6. The coated transparency as recited in claim 1 wherein the coating comprises a conductive polymer.

7. The coated transparency as recited in claim 1 wherein the coating comprises polyaniline.

8. The coated transparency as recited in claim 7 wherein the coating comprises a resin selected from the group of resins consisting of polysiloxane, polyurethane and acrylate and wherein the coating is transparent and conductive.

9. The coated transparency as recited in claim 8 wherein the coating comprises nanotubes in the range of about 0.01 to about 30.0 percent by weight.

10. The coated transparency as recited in claim 1 wherein the coating comprises nanotubes in the range of about 0.01 to about 30.0 percent by weight.

11. The coated transparency as recited in claim 1 wherein the transparency is an aircraft windshield.

12. The coated transparency as recited in claim 1 wherein the coating has a light transmission of at least about 70%.

13. A method of forming a coated transparency comprising:
providing a transparency;
applying a resin to the transparency; and
spraying nanotubes onto the resin.

14. The method as recited in claim 13 wherein prior to spraying the method further comprises dispersing the nanotubes in a solvent.

15. The method as recited in claim 14 wherein the solvent is selected from the group of solvents consisting of water, ethanol, CHCl₃, tetrahydrofuran, and dimethyl formamide.

16. The method as recited in claim 13 wherein prior to spraying the method further comprises dispersing nanotubes in a water solution comprising sodium dodecylsulfate forming a solution comprising nanotubes.

17. The method as recited in claim 16 further comprising dispersing the solution comprising nanotubes in a solvent selected from the group of solvents consisting of water, ethanol, and dimethyl formamide.

18. The method as recited in claim 13 further comprising mixing the nanotubes with a conductive polymer.

19. The method as recited in claim 13 further comprising mixing the nanotubes with polyaniline.

20. The method as recited in claim 13 wherein applying a resin comprises applying a resin selected from the group of resins consisting of polysiloxanes, polyurethanes and acrylates.

21. A method for forming a coated transparency comprising:
providing a transparency;
mixing nanotubes with a resin; and
applying the resin to the transparency.

22. The method as recited in claim 21 wherein the resin is selected from the group of resins consisting of polysiloxanes, polyurethanes and acrylates.

23. The method as recited in claim 21 further comprising mixing the nanotubes with a conductive polymer.

24. The method as recited in claim 21 further comprising mixing the nanotubes with polyaniline.

25. The method as recited in claim 24 wherein prior to mixing the nanotubes with the polyaniline, the method comprises dispersing the nanotubes in a solution of sodium dodecylsulfate.

26. The method as recited in claim 24 further comprising doping the polyaniline with sodium dodecyl benzenesulfonic acid.

27. The method as recited in claim 24 further comprising mixing the polyaniline with a solvent selected from the group of solvents consisting of ethanol, CHCl₃, isopropanol, acetone, and tetrahydrofuran.

28. The method as recited in claim 24 further comprising dispersing the nanotubes in a solution consisting of a solvent selected from the group of solvents consisting of water, ethanol, CHCl₃, tetrahydrofuran, and dimethyl formamide.

29. The method as recited in claim 21 further comprising mixing a conductive polymer with the nanotubes and the resin.

30. The method as recited in claim 21 further comprising mixing polyaniline with the nanotubes and the resin.

31. A method for forming a coated transparency comprising:
providing a transparency;
applying a layer of resin over the transparency; and
applying nanotubes to the resin.

32. The method as recited in claim 31 wherein the resin is selected from the group of resins consisting of polysiloxanes, polyurethanes and acrylates.

33. The method as recited in claim 31 further comprising mixing the nanotubes with a conductive polymer.

34. The method as recited in claim 31 further comprising mixing the nanotubes with polyaniline.

35. The method as recited in claim 34 wherein prior to mixing the nanotubes with polyaniline the method comprises dispersing the nanotubes in a solution of sodium dodecylsulfate.

36. The method as recited in claim 34 further comprising doping the polyaniline with sodium dodecyl benzenesulfonic acid.

37. The method as recited in claim 34 further comprising mixing the polyaniline with a solvent selected from the group of solvents consisting of ethanol, CHCl₃, isopropanol, acetone, and tetrahydrofuran.

38. The method as recited in claim 34 further comprising dispersing the nanotubes in a solution consisting of a solvent selected from the group of solvents consisting of water, ethanol, CHCl₃, tetrahydrofuran, and dimethyl formamide.

39. The method as recited in claim 31 wherein applying comprises spreading the nanotubes over the layer of resin.
